(19) United States
(12) Patent Application Publication
(10) Pub. No.: US 2025/0225742 A1
(43) Pub. Date: Jul. 10, 2025

(54) METHOD FOR PROVIDING INFORMATION BASED ON GAZE POINT AND ELECTRONIC DEVICE THEREFOR

(71) Applicant: Samsung Electronics Co., Ltd., Suwon-si (KR)

(72) Inventors: Jinmo KANG, Suwon-si (KR); Beomsu KIM, Suwon-si (KR); Sungoh KIM, Suwon-si (KR); Gunhee LEE, Suwon-si (KR); Sanghun LEE, Suwon-si (KR); Sunyoung JUNG, Suwon-si (KR); Jihyun KIM, Suwon-si (KR); Donghyun YEOM, Suwon-si (KR)

(21) Appl. No.: 19/089,794

(22) Filed: Mar. 25, 2025

Related U.S. Application Data
(63) Continuation of application No. PCT/KR2023/014535, filed on Sep. 22, 2023.

(30) Foreign Application Priority Data
Sep. 28, 2022 (KR) 10-2022-0123011
Nov. 25, 2022 (KR) 10-2022-0160908

(51) Int. Cl. G06T 19/00; G02B 27/00; G02B 27/01

(52) U.S. Cl. CPC G06T 19/006; G02B 27/0093; G02B 27/017; G02B 2027/0138

(57) ABSTRACT

A head mounted display (HMD) device is provided. The HMD includes a display, a gaze sensor configured to detect a gaze direction of a user of the HMD device, a camera, a position sensor configured to detect a position of the HMD device, communication circuitry, memory storing one or more computer programs, and one or more processors communicatively coupled to the display, the gaze sensor, the camera, the position sensor, the communication circuitry, and the memory, wherein the one or more computer programs include computer-executable instructions that, when executed by the one or more processors individually or collectively, cause the HMD device to, based on the position of the HMD device, acquire three-dimensional (3D) segmentation information for a space corresponding to the position of the HMD device, acquire gaze point-based interest information corresponding to a profile of the user, the gaze point-based interest information including interest information generated based on gaze points of a plurality of users, display, on the display, a first visual effect for a plurality of regions in the space based on the 3D segmentation information and the interest information, and display, on the display, a second visual effect for a plurality of objects in a first region among the plurality of regions based on the 3D segmentation information and the interest information when the position of the HMD device corresponds to the first region.

### CROSS-REFERENCE TO RELATED APPLICATION(S)

This application is a continuation application, claiming priority under 35 U.S.C. § 365 (c), of an International application No. PCT/KR2023/014535, filed on Sep. 22, 2023, which is based on and claims the benefit of a Korean patent application number 10-2022-0123011, filed on Sep. 28, 2022, in the Korean Intellectual Property, and of a Korean patent application number 10-2022-0160908, filed on Nov. 25, 2022, in the Korean Intellectual Property, the disclosure of each of which is incorporated by reference herein in its entirety.

### BACKGROUND

### 1. Field

The disclosure relates to a method for providing information based on a gaze point and an electronic device therefor.

### 2. Description of Related Art

As portable devices become smaller, various wearable devices are being studied. A wearable device may be referred to as a device capable of being worn on a part of a user's body. For example, a wearable device such as smart glasses may provide a user with augmented reality (AR) or virtual reality (VR). In augmented reality, the user may view real space through a transparent display of smart glasses. The smart glasses may provide the augmented reality to the user by projecting virtual content onto the real space. The smart glasses may be referred to as AR glasses or an AR device. In virtual reality, the user may view the virtual space through a display device worn on his or her head. The display device may provide the virtual reality to the user by projecting virtual content into the virtual space. A device that provides augmented reality or virtual reality may be referred to as a head mounted display (HMD) device.

In this regard, the user may wear the HMD device capable of outputting virtual content and then execute a program in the HMD device. The HMD device may output, on a display, virtual content based on the execution of the program. Accordingly, the user may recognize information about virtual content output on the display.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for providing information based on a gaze point and an electronic device therefor.

Additional aspects will be set forth in part in the description which follows and, in part, will be apparent from the description, or may be learned by practice of the presented embodiments.

In accordance with an aspect of the disclosure, a head mounted display (HMD) device is provided. The HMD device includes a display, a gaze sensor configured to detect a gaze direction of a user of the HMD device, a camera, a position sensor configured to detect a position of the HMD device, communication circuitry, memory storing one or more computer programs, and one or more processors communicatively coupled to the display, the gaze sensor, the camera, the position sensor, the communication circuitry, and the memory, wherein the one or more computer programs include computer-executable instructions that, when executed by the one or more processors individually or collectively, cause the electronic device to, based on the position of the HMD device, acquire three-dimensional (3D) segmentation information for a space corresponding to the position of the HMD device, acquire gaze point-based interest information corresponding to a profile of the user, the gaze point-based interest information including interest information generated based on gaze points of a plurality of users, display, on the display, a first visual effect for a plurality of regions in the space based on the 3D segmentation information and the interest information, and display, on the display, a second visual effect for a plurality of objects in a first region among the plurality of regions based on the 3D segmentation information and the interest information when the position of the HMD device corresponds to the first region.

In accordance with another aspect of the disclosure, a method performed by a head-mounted display (HMD) device for providing a visual effect is provided. The method includes based on a position of the HMD device, acquiring, by the HMD device, three-dimensional (3D) segmentation information for a space corresponding to the position of the HMD device, acquiring, by the HMD device, gaze point-based interest information corresponding to a profile of a user of the HMD device, the gaze point-based interest information including interest information generated based on gaze points of a plurality of users, displaying, by the HMD device on a display of the HMD device, a first visual effect for a plurality of regions in the space based on the 3D segmentation information and the interest information, and displaying, by the HMD device on the display, a second visual effect for a plurality of objects in a first region among the plurality of regions based on the 3D segmentation information and the interest information in response to the position of the HMD device corresponding to the first region.

In accordance with another aspect of the disclosure, one or more non-transitory computer-readable storage media storing one or more computer programs including computer-executable instructions that, when executed by one or more processors of a head-mounted display (HMD) device individually or collectively, cause the HMD device to perform operations are provided. The operations include, based on a position of the HMD device, acquiring, by the HMD device, three-dimensional (3D) segmentation information for a space corresponding to the position of the HMD device, acquiring, by the HMD device, gaze point-based interest information corresponding to a profile of a user of the HMD device, the gaze point-based interest information including interest information generated based on gaze points of a plurality of users, displaying, by the HMD device on a display of the HMD device, a first visual effect for a plurality of regions in the space based on the 3D segmentation information and the interest information, and displaying, by the HMD device on the display, a second visual effect for a plurality of objects in a first region among the plurality of regions based on the 3D segmentation information and the interest information in response to the position of the HMD device corresponding to the first region.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a schematic view illustrating an electronic device according to an embodiment of the disclosure;

FIG. 3 is a schematic diagram of a method for eye-tracking and display through a transparent member, according to an embodiment of the disclosure;

FIG. 4 is a block diagram of an electronic device according to an embodiment of the disclosure;

FIG. 5 illustrates three-dimensional segmentation according to an embodiment of the disclosure;

FIG. 6 illustrates object-based gaze point analysis according to an embodiment of the disclosure;

FIG. 7 illustrates surface-based gaze point analysis according to an embodiment of the disclosure;

FIG. 8 illustrates a spatial configuration according to an embodiment of the disclosure;

FIG. 9 illustrates a first visual effect according to an embodiment of the disclosure;

FIG. 10A illustrates a second visual effect according to an embodiment of the disclosure;

FIG. 10B illustrates a third visual effect according to an embodiment of the disclosure;

FIG. 11 illustrates a fourth visual effect according to an embodiment of the disclosure;

FIG. 12 is a signal flow diagram of a method for analyzing a gaze point according to an embodiment of the disclosure;

FIG. 13 is a signal flow diagram of a method for providing a visual effect according to an embodiment of the disclosure;

FIG. 14 is a flowchart of a method for providing a position-based visual effect according to an embodiment of the disclosure; and

FIG. 15 is a flowchart of a method for providing a position-based visual effect according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

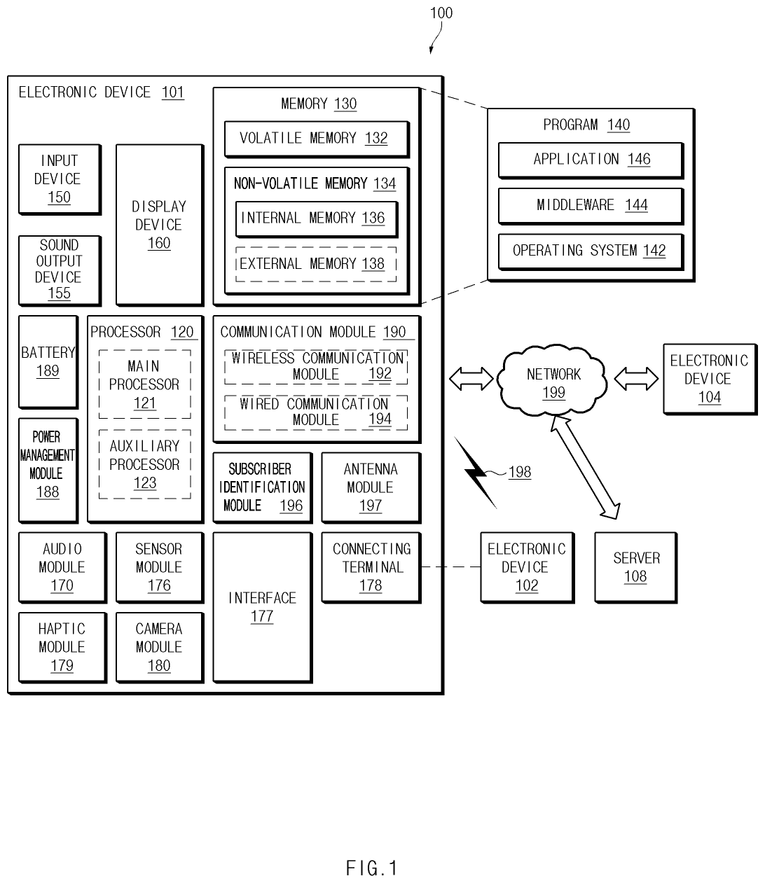

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display device 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, a keyboard, a key (e.g., a button), or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

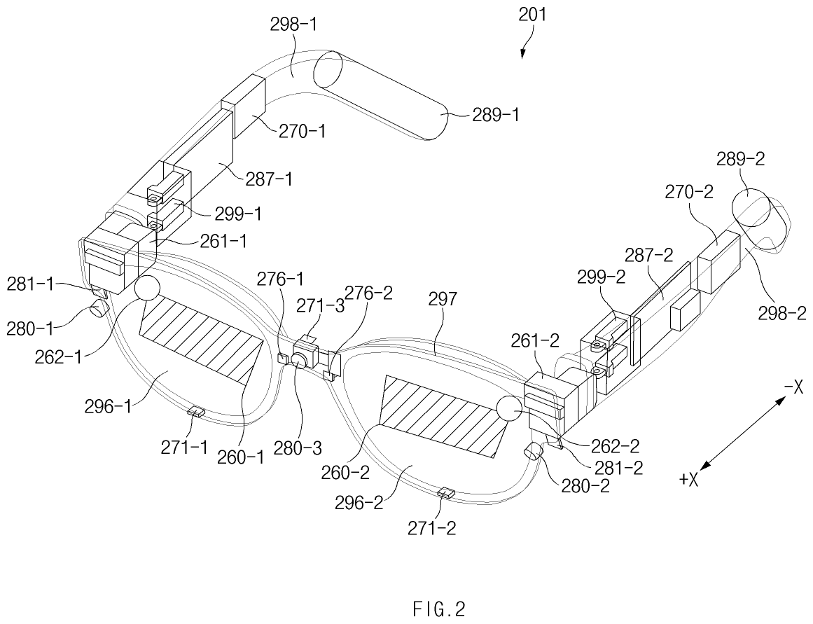

FIG. 2 is a schematic diagram illustrating an electronic device according to an embodiment of the disclosure.

Referring to FIG. 2, an electronic device 201 may be referred to as a head-mounted display (HMD) device, a wearable device, smart glasses, or an eyewear. The shape of the electronic device 201 illustrated in FIG. 2 is merely an example, and embodiments of the disclosure are not limited thereto. For example, the electronic device 201 may be any electronic device configured to provide augmented reality (AR) or virtual reality (VR).

According to an example, the electronic device 201 may include at least some components of the electronic device 101 in FIG. 1. For example, the electronic device 201 may include at least one of a display (e.g., the display device 160 in FIG. 1), a camera (e.g., the camera module 180 in FIG. 1), at least one sensor (e.g., the sensor module 176 in FIG. 1), a processor (e.g., the processor 120 in FIG. 1), a battery (e.g., the battery 189 in FIG. 1), memory (e.g., memory 130 in FIG. 1), or communication circuitry (e.g., the communication module 190 in FIG. 1). At least some of the components of the electronic device 201 may be positioned inside the housing of the electronic device 201 or may be exposed to the outside of the housing.

According to an embodiment, the electronic device 201 may include a display. For example, the electronic device 201 may include a first display 261-1 and/or a second display 261-2. The first display 261-1 and/or the second display 261-2 may include at least one of a liquid crystal display (LCD), a digital mirror device (DMD), a liquid crystal on silicon device (LCoS device), a light emitting diode (LED) on silicon device (LEDoS device), an organic light emitting diode (OLED), or a micro light emitting diode (micro LED). For example, the display of the electronic device 201 may include at least one light source to emit lights. When the first display 261-1 and/or the second display 261-2 includes one of a liquid crystal display device, a digital mirror device, or a liquid crystal on silicon device, the electronic device 201 may include at least one light source for irradiating lights to (a) screen output area(s) (e.g., first screen output area 260-1 and/or second screen output area 260-2) of the display. For another example, when the display of the electronic device 201 generates light by itself, the display may not include a separate light source other than the light source included in the display. When the first display 261-1 and/or the second display 261-2 includes at least one of an organic light emitting diode and a micro LED, the electronic device 201 may provide an image to the user even if it does not include any other separate light sources. The weight of the electronic device 201 may be reduced by omitting a separate light source when the display is implemented by an organic light emitting diode or a micro LED.

According to one embodiment, the electronic device 201 may include a first transparent member 296-1 and/or a second transparent member 296-2. For example, when the user wears the electronic device 201, the user may see through the first transparent member 296-1 and/or the second transparent member 296-2. The first transparent member 296-1 and/or the second transparent member 296-2 may be formed of at least one of a glass plate, a plastic plate, or a polymer, and may be transparent or translucent. For example, when worn, the first transparent member 296-1 may be disposed to face the user's right eye, and the second transparent member 296-2 may be disposed to face the user's left eye.

According to an example, at least a portion of the first transparent member 296-1 and/or the second transparent member 296-2 may be an optical waveguide. For example, the optical waveguide may transmit an image generated by a display (e.g., the first display 261-1 and/or the second display 261-2) to the user's eyes. The optical waveguide may be formed of glass, plastic, or polymer. For example, the optical waveguide may include a nano-pattern (e.g., a polygonal or curved grating structure) formed inside or on one surface. For example, light incident to one end of the optical waveguide may be propagated inside the optical waveguide by a nano-pattern and provided to the user's eyes. For example, the optical waveguide including a free-form prism may be configured to provide incident light to the user through a reflection mirror.

According to an example, the optical waveguide may include at least one of at least one diffractive element (e.g., a diffractive optical element (DOE), or a holographic optical element (HOE)) or a reflective element (e.g., a reflective mirror). The optical waveguide may guide the display light emitted from the light source to the user's eyes using at least one diffractive element or the reflective element included in the optical waveguide. For example, the diffractive element may include an input optical member (e.g., first input optical member 262-1 and/or second input optical member 262-2) and/or an output optical member (not illustrated). The first input optical member 262-1 and/or the second input optical member 262-2 may be referred to as an input grating area, and the output optical member (not illustrated) may be referred to as an output grating area. The input grating area may diffract or reflect light in order to transmit light output from a light source (e.g., the micro LED) to a transparent member (e.g., the first transparent member 296-1 and/or the second transparent member 296-2) of a screen display unit. The output grating area may diffract or reflect the light transmitted to the transparent member (e.g., the first transparent member 296-1 and/or the second transparent member 296-2) of the optical waveguide in the direction toward the user's eyes. For example, the reflective element may include a total reflection optical element or a total reflection waveguide for total internal reflection (TIR). Total reflection may be referred to as one way of guiding light, and may mean making an incident angle so that the light (e.g., image) input through the input grating area is 100% reflected from one surface (e.g., the specific surface) of the optical waveguide and is 100% transmitted to the output grating area. In an example, an optical path of the light emitted from the display may be guided to the optical waveguide by the input optical member. The light moving inside the optical waveguide may be guided toward the user's eyes through the output optical member. The screen output area(s) (e.g., first screen output area 260-1 and/or second screen output area 260-2) may be determined based on light emitted in the eye direction.

The electronic device 201 has been described as providing an image to the user by using the optical waveguide in FIG. 2, but the embodiments of the disclosure are not limited thereto. For example, the display of the electronic device 201 may be a transparent or translucent display. In this case, the display may be disposed at a position facing the user's eyes (e.g., first screen output area 260-1 and/or second screen output area 260-2).

According to an example, the electronic device 201 may include at least one camera. For example, the electronic device 201 may include a first camera 280-1, a second camera 280-2, and/or a third camera 280-3. For example, the first camera 280-1 and the second camera 280-2 may be used for external image recognition. The first camera 280-1 and the second camera 280-2 may be configured to acquire an image corresponding to a direction (e.g., a +x direction) corresponding to the gaze of the user. The electronic device 201 may use the first camera 280-1 and the second camera 280-2 to perform head tracking (e.g., 3 degrees of freedom (DoF) or 6 degrees of freedom tracking), hand image detection, hand image tracking, and/or spatial recognition. For example, the first camera 280-1 and the second camera 280-2 may be a global shutter (GS) camera having the same specifications and performance (e.g., the angle of view, shutter speed, resolution, and/or the number of color bits, or the like). The electronic device 201 may support simultaneous localization and mapping (SLAM) technology by performing spatial recognition (e.g., 6-DOF spatial recognition) and/or depth information acquisition using stereo cameras disposed on the right and left. In addition, the electronic device 201 may recognize the gesture of the user with stereo cameras disposed on the right and left. The electronic device 201 may detect a faster hand gesture and fine movement by using a GS camera having relatively less distortion than a rolling shutter (RS) camera. For example, the third camera 280-3 may be used for external image recognition. The third camera 280-3 may be configured to acquire an image corresponding to a direction (e.g., the +x direction) corresponding to the gaze of the user. In an example, the third camera 280-3 may be a camera having a relatively higher resolution than those of the first camera 280-1 and the second camera 280-2. The third camera 280-3 may be referred to as a high resolution (HR) camera or a photo video (PV) camera. The third camera 280-3 may support functions for acquiring a high-quality image, such as auto focus (AF) and/or optical image stabilization (OIS). The third camera 280-3 may be a GS camera or an RS camera.

According to an example, the electronic device 201 may include at least one eye-tracking sensor. For example, the electronic device 201 may include a first eye-tracking sensor 276-1 and a second eye-tracking sensor 276-2. The first eye-tracking sensor 276-1 and the second eye-tracking sensor 276-2 may be, for example, cameras configured to acquire an image in a direction corresponding to the user's eyes. The first eye-tracking sensor 276-1 and the second eye-tracking sensor 276-2 may be configured to acquire the user's right eye image and the user's left eye image, respectively. The electronic device 201 may be configured to detect the user's pupil using the first eye-tracking sensor 276-1 and the second eye-tracking sensor 276-2. The electronic device 201 may acquire the gaze of the user from the user's pupil image and provide the image based on the acquired gaze. For example, the electronic device 201 may display the image so that the image is positioned in the direction of the gaze of the user. For example, the first eye-tracking sensor 276-1 and the second eye-tracking sensor 276-2 may be a global shutter (GS) camera having the same specifications and performance (e.g., the angle of view, shutter speed, resolution, and/or the number of color bits, or the like).

According to an example, the electronic device 201 may include at least one illumination unit. The illumination unit may include, for example, at least one LED. In FIG. 2, the electronic device 201 may include a first illumination unit 281-1 and a second illumination unit 281-2. The electronic device 201 may, for example, use the first illumination unit 281-1 and the second illumination unit 281-2 to provide auxiliary illumination for the first camera 280-1, the second camera 280-2, and/or the third camera 280-3. In an example, the electronic device 201 may provide illumination for acquiring a pupil image using the illumination unit (not shown). For example, the electronic device 201 may provide illumination to the eye-tracking sensor by using an LED covering an infrared wavelength. In this case, the eye-tracking sensor may include an image sensor for acquiring an infrared wavelength image.

According to an example, the electronic device 201 may include at least one printed circuit board (PCB). For example, the electronic device 201 may include a first PCB 287-1 positioned in a first temple 298-1 and a second PCB 287-2 positioned in a second temple 298-2. The first PCB 287-1 and/or the second PCB 287-2 may be electrically connected to other components of the electronic device 201 through a signal line and/or a flexible PCB (FPCB). For example, the communication circuitry, the memory, at least one sensor, and/or the processor may be disposed on the first PCB 287-1 and/or the second PCB 287-2. For example, each of the first PCB 287-1 and the second PCB 287-2 may be constituted by a plurality of PCBs that are spaced apart by interposers.

According to an example, the electronic device 201 may include at least one battery. For example, the electronic device 201 may include a first battery 289-1 positioned at one end of the first temple 298-1 and a second battery 289 positioned at one end of the second temple 298-2. The first battery 289-1 and a second battery 289-2 may be configured to supply power to components of the electronic device 201.

According to an example, the electronic device 201 may include at least one speaker. For example, the electronic device 201 may include a first speaker 270-1 and a second speaker 270-2. The electronic device 201 may be configured to provide stereo sound using speakers positioned on the right and left.

According to an example, the electronic device 201 may include at least one microphone. For example, the electronic device 201 may include a first microphone 271-1, a second microphone 271-2, and/or a third microphone 271-3. The first microphone 271-1 may be positioned to the right of a frame 297, the second microphone 271-2 may be positioned to the left of the frame 297, and the third microphone 271-3 may be positioned on a bridge of the frame 297. In an example, the electronic device 201 may perform beamforming by using the first microphone 271-1, the second microphone 271-2, and/or the third microphone 271-3.

According to an example, the electronic device 201 may include the first temple 298-1, the second temple 298-2, and the frame 297. The first temple 298-1, the second temple 298-2, and the frame 297 may be referred to as the housing. The first temple 298-1 may be physically connected to the frame 297 through a first hinge portion 299-1, and may support the frame 297 when worn. The second temple 298-2 may be physically connected to the frame 297 through a second hinge portion 299-2, and may support the frame 297 when worn.

The configuration of the above-described electronic device 201 is merely an example, and the embodiments of the disclosure are not limited thereto. For example, the electronic device 201 may not include at least some of the components described with reference to FIG. 2, or may further include components other than the described components. For example, the electronic device 201 may include at least one sensor (e.g., an acceleration sensor, a gyro sensor, and/or a touch sensor) and/or an antenna.

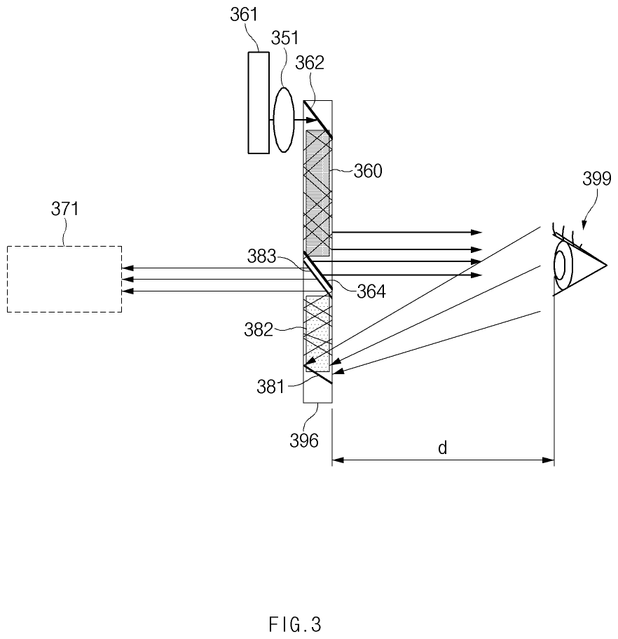

FIG. 3 is a schematic diagram of a method for eye-tracking and display through a transparent member, according to an embodiment of the disclosure.

Referring to FIG. 3, a display 361 (e.g., the first display 261-1 or the second display 261-2 in FIG. 2) may provide an image through a transparent member 396 (e.g., the first transparent member 296-1 or the second transparent member 296-2 in FIG. 2). According to an example, the display 361 may input light corresponding to the image to an input optical member 362 (e.g., the first input optical member 262-1 or the second input optical member 262-2 in FIG. 2) through a lens 351. The input optical member 362 may reflect or diffract the incident light so that the reflected or diffracted light is input into an optical waveguide 360. An output optical member 364 may output the light transmitted through the optical waveguide 360 toward a user's eye 399. In an example, the lens 351 may be included in the display 361. In an example, the position of the lens 351 may be determined based on a distance d between the transparent member 396 and the user's eye 399.

According to an embodiment, an eye-tracking sensor 371 (e.g., the first eye-tracking sensor 276-1 or the second eye-tracking sensor 276-2 in FIG. 2) may acquire an image corresponding to at least a part of the user's eye 399. For example, light corresponding to the image of the user's eye 399 may be reflected and/or diffracted by a first splitter 381 and input to an optical waveguide 382. The light transmitted to a second splitter 383 through the optical waveguide 382 may be reflected and/or diffracted by the second splitter 383 and output toward the eye-tracking sensor 371.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

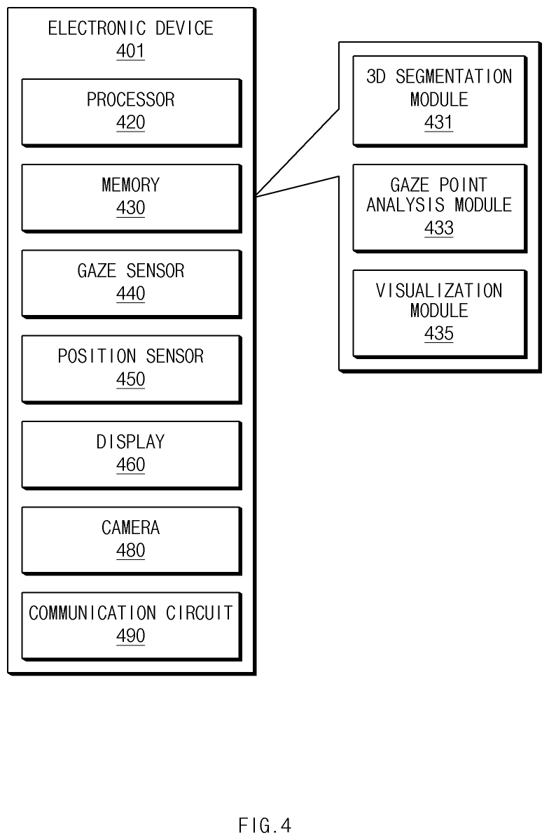

FIG. 4 is a block diagram of an electronic device according to an embodiment of the disclosure.

Referring to FIG. 4, according to an embodiment, an electronic device 401 may include a processor 420, memory 430, a gaze sensor 440, a position sensor 450, a display 460, a camera 480, and/or communication circuitry 490. For example, the electronic device 401 may correspond to the electronic device 101 in FIG. 1 and/or the electronic device 201 in FIG. 2. In various embodiments of the disclosure, the electronic device 401 is a device that provides AR content or video see-through (VST) content, and may be referred to as AR glasses or an AR device. In various embodiments of the disclosure, the electronic device 401 may be referred to as a device that provides VR content. The electronic device 401 may be a wearable device that may be worn on a user's head. For example, the electronic device 401 may be referred to as an HMD device. For example, the processor 420 may correspond to the processor 120 in FIG. 1. For example, the memory 430 may correspond to the memory 130 in FIG. 1. For example, the gaze sensor 440 may correspond to the sensor module 176 in FIG. 1, the first eye-tracking sensor 276-1 in FIG. 2, and/or the second eye-tracking sensor 276-2 in FIG. 2. For example, the position sensor 450 may correspond to the sensor module 176 in FIG. 1. For example, the display 460 may correspond to the display device 160 in FIG. 1, the first display 261-1 in FIG. 2, and/or the second display 261-2 in FIG. 2. The camera 480 may correspond to the camera module 180 in FIG. 1, the first camera 280-1 in FIG. 2, the second camera 280-2 in FIG. 2, and/or the third camera 280-3 in FIG. 3. For example, the communication circuitry 490 may correspond to the communication module 190 in FIG. 1. The components of the electronic device 401 in FIG. 4 is merely an example, and the electronic device 401 may further include a component not illustrated in FIG. 4.

The processor 420 may be electrically, operatively, or functionally connected to the memory 430, the gaze sensor 440, the position sensor 450, the display 460, the camera 480, and/or the communication circuitry 490. In various embodiments of the disclosure, when one component is “operatively” connected to another component, it may mean that the component is connected to operate the other component. For example, one component may operate another component by transmitting a control signal to the other component, either directly or via the still another component. In various embodiments of the disclosure, when one component is “functionally” connected to another component, it may mean that the component is connected to execute a function of the other component. For example, one component may execute a function of another component by transmitting a control signal to the other component, either directly or via the yet another component.

The memory 430 may store instructions. When the instructions are executed by the processor 420, the instructions may cause the electronic device 401 to perform various operations. In various embodiments of the disclosure, the operation of the electronic device 401 may be referred to as an operation performed by the processor 420 by executing instructions stored in the memory 430.

The gaze sensor 440 may detect a gaze direction of a user (e.g., a wearer) of the electronic device 401. The gaze sensor 440 may acquire an image of user's eyes, for example, using a camera directed toward user's eyes. In an example, the gaze sensor 440 may acquire the image of the user's eyes using infrared light. The processor 420 may identify the gaze direction using the image of the eyes acquired by the gaze sensor 440. For example, the processor 420 may identify the gaze direction of a wearer by detecting a gaze vector based on positions of the pupils of both eyes. In an example, the processor 420 may identify the gaze direction as described above with respect to the first eye-tracking sensor 276-1 in FIG. 2 and/or the second eye-tracking sensor 276-2 in FIG. 2.

The position sensor 450 may detect positions of the electronic device 401. For example, the position sensor 450 may detect the position of the electronic device 401 based on at least one of a satellite signal, a beacon signal, triangulation, and/or an angle of arrival. The position sensor 450 may detect a geographical position of the electronic device 401 by receiving signals from satellites. The position sensor 450 may detect the position of the electronic device 401 from information on positions of beacons by using signals received from nearby beacons. The position sensor 450 may detect the position of the electronic device 401 based on triangulation. For example, the position sensor 450 may perform triangulation based on signals received from two or more signal transmitting devices (e.g., base stations or beacons). For example, the position sensor 450 may measure the angle of arrival of a signal received from a nearby signal transmitting device and detect the position of the electronic device 401 based on the angle of arrival and the position of the nearby signal transmitting device. In an example, the electronic device 401 may use a position input by the user as the position of the electronic device 401. In an example, the electronic device 401 may use a relative (or logical) position of the electronic device 401 within the virtual space as the position of the electronic device 401.

The display 460 may be positioned in front of the user's eyes when worn. The display 460 may be a display worn on a user's head. In an example, the display 460 may include a transparent display through which the user may see. For example, the processor 420 may project AR content onto an area on the transparent display so that a user may view the real world and the projected image simultaneously. For example, the processor 420 may display an image on pixels positioned on the transparent display, thereby allowing the user to view both the real world and the projected image simultaneously. In an example, the display 460 may be an opaque display. The processor 420 may acquire a real-world image in front of the user (e.g., a direction in which a user's face is facing) using the camera 480 and display AR content by overlaying the AR content on the real-world image. In an example, the display 460 may be an opaque display. The processor 420 may display VR content by overlaying the VR content on the virtual space.

The camera 480 may be configured to acquire an image of an area corresponding to an area in front of the user (e.g., the direction in which the user's face is facing) when worn. The camera 480 may include at least one camera.

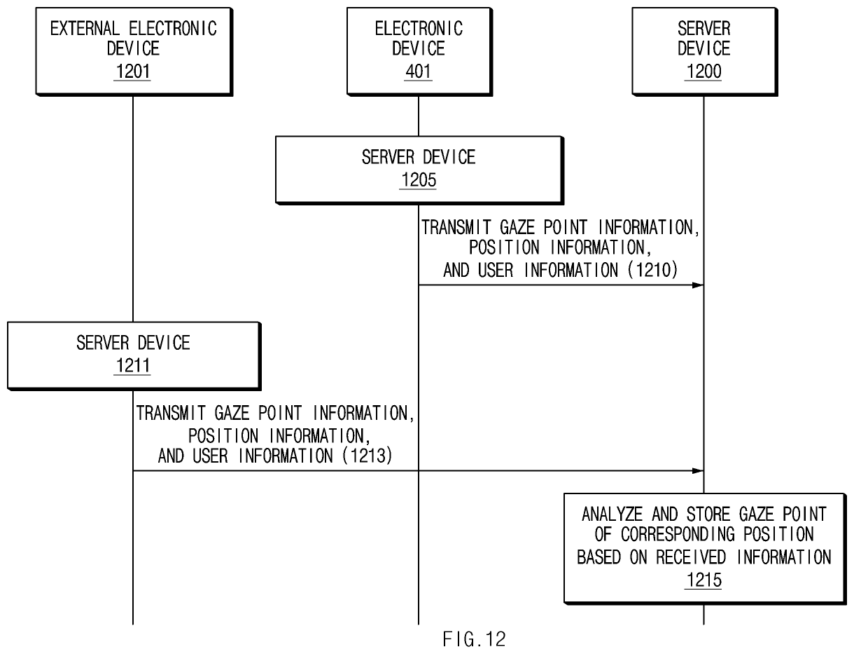

The communication circuitry 490 may provide communication between the electronic device 401 and another electronic device (e.g., a server device 1200 in FIG. 12). The communication circuitry 490 may support wired communication and/or wireless communication. The communication circuitry 490 may support short-range wireless communication and/or long-range wireless communication.

According to an embodiment, the electronic device 401 may include a 3D segmentation module 431, a gaze point analysis module 433, and/or a visualization module 435. The modules 431, 433, and 435 of the electronic device 401 illustrated in FIG. 4 may be software modules, and may be modules implemented by the processor 420 by executing instructions stored in the memory 430. The operations of the modules 431, 433, and 435 of the electronic device 401 to be described below may be referred to as operations of the processor 420.

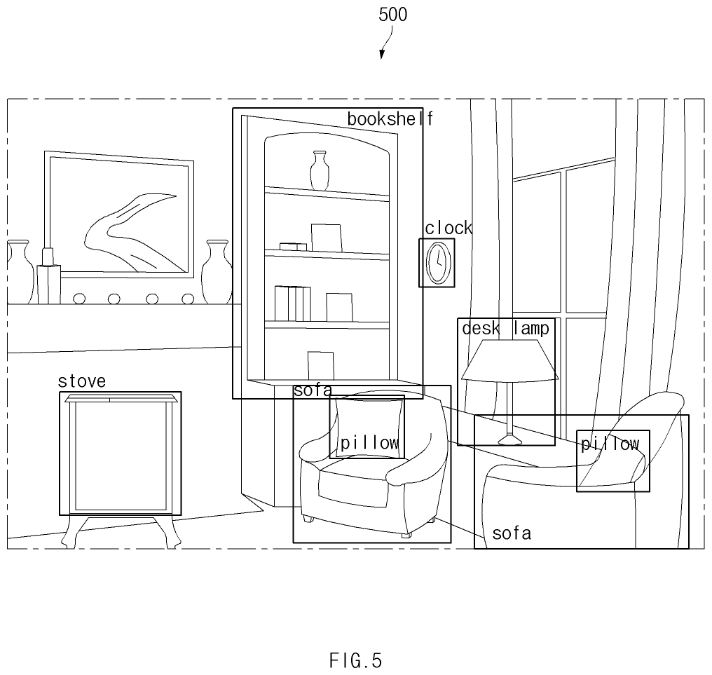

The 3D segmentation module 431 may perform 3D segmentation on an image acquired using the camera 480. The 3D segmentation may refer to object-based segmentation for a space corresponding to the image. For example, the 3D segmentation module 431 may identify a meaningful object from the image through semantic analysis of the image. The 3D segmentation module 431 may refer to boundary and/or depth information for identification of the object. For example, the 3D segmentation module 431 may identify a 3D object based on machine learning. The 3D segmentation module 431 may identify a 3D object that is distinct from the background and identify a type and/or a name of the 3D object. The 3D segmentation by the 3D segmentation module 431 may be described below with reference to FIG. 5.

The gaze point analysis module 433 may collect and analyze gaze points of the user. For example, the gaze point analysis module 433 may identify the gaze direction of the user using the gaze sensor 440. The gaze point analysis module 433 may identify a point at which the user gazes in the real-world image acquired using the camera 480.

The gaze point analysis module 433 may, in an example, perform gaze point analysis on an object basis. The gaze point analysis module 433 may perform gaze point analysis for each object identified by the 3D segmentation module 431. The gaze point analysis module 433 may identify, for example, the gaze point of the user for a plurality of objects (e.g., objects in the image acquired by the camera 480 or objects in the virtual space). The object-basis gaze analysis may be performed, for example, by analyzing how often, how long, and at what object the user gazes. For example, when a user's interest in a specific object is high, the time the user gazes at the specific object may be relatively longer than other objects.

The gaze point analysis module 433 may, in an example, perform surface-based gaze point analysis. For example, the gaze point analysis module 433 may analyze a gaze point of the user on a surface of an object. For example, when a user's interest in a specific part of a specific object is high, the time the user gazes at the specific part may be relatively longer than other objects.

According to an embodiment, the gaze point analysis module 433 may filter information about a space, an object, and/or a surface to be visualized using gaze point information. For example, the gaze point information may be acquired from the memory 430 of the electronic device 401 or a server device (e.g., the server device 1200 in FIG. 12). For example, the gaze point information may include information based on gaze point analysis statistics for the space, the object, and/or the surface. The gaze point analysis statistics may be statistically acquired information based on a user profile. The user profile may include, for example, at least one of a gender, an age, interests, or a residence region of the user. For example, the gaze analysis statistics may be information indicating that a male user in 40s has a high level of interest (e.g., long gaze time) in a specific space, an object, and/or a surface region. The gaze analysis statistics may show, for example, that male users in their 40s have different tendencies than female users in their 20s. The gaze point analysis module 433 may use the gaze point information to filter information corresponding to the user profile of the electronic device 401. The gaze point analysis module 433 may transmit, to the visualization module 435, a level of interest for which a visual effect is to be provided based on gaze point analysis statistics corresponding to the user profile of the electronic device 401. The gaze point analysis module 433 may, through filtering, transmit interest information about the space, the object, and/or the object surface of a current space that matches the user of the electronic device 401 to the visualization module 435. Although the interest information has been described with a focus on statistical information, the embodiments of the disclosure are not limited thereto. For example, the interest information may be set by the user of the electronic device 401 or by the manufacturer of the electronic device 401.

According to an embodiment, the visualization module 435 may provide a visual effect using the position of the electronic device 401 and the gaze point information. For example, the electronic device 401 may acquire position information about the electronic device 401 using a position sensor 450. For example, the electronic device 401 may acquire the position of the electronic device 401 on a space map corresponding to the current space using the image acquired from the camera 480 (e.g., the first camera 280-1 and/or the second camera 280-2 in FIG. 2). For example, the electronic device 401 may acquire the position of the electronic device 401 in space through the image acquired using the camera 280 and simultaneous localization and mapping (SLAM) based on the space map.

For example, when gaze point information for a specific space indicates high interest, the visualization module 435 may provide a visual effect that may highlight the corresponding space. For example, the gaze point information for the specific space may include interest information identified based on at least one of gaze points of a plurality of users for the specific space or a stayed time within the specific space. For example, the visual effect may include at least one of shading, highlights, icons, text, or a graphical user interface (GUI) that is mapped and displayed in the corresponding space. For example, the visualization module 435 may display the visual effect on a display region corresponding to the corresponding space, thereby allowing the user to see the space and the visual effect overlapped therewith.

For example, when gaze point information on a specific object indicates high interest, the visualization module 435 may provide a visual effect that may highlight the object. For example, the gaze point information for the specific object may include interest information identified based on gaze points of a plurality of users for the specific object. For example, the visual effect may include at least one of a shading, highlight, icon, text, or a graphical user interface (GUI) that is mapped to and displayed on the corresponding object. For example, the visualization module 435 may display the visual effect on a display region corresponding to the object, thereby allowing the user to see the object and the visual effect overlapped therewith.

The visualization module 435 may provide a visual effect based on 3D segmentation information and the gaze point information. For example, the 3D segmentation information may include hierarchical segmentation information for a space corresponding to the position of the electronic device 401. In an example, the 3D segmentation information may include information for dividing the space into a plurality of regions. The gaze point information may include interest information corresponding to the user of the electronic device 401 for the plurality of regions. The 3D segmentation information may include information about objects included in each of the plurality of regions. The gaze point information may include interest information corresponding to the user of the electronic device 401 for each of the objects. For example, the visualization module 435 may identify an object in the space that the user is currently viewing using the 3D segmentation information and provide a visual effect for the object based on interest information corresponding to the object.

The visualization module 435 may provide a visual effect based on the position of the electronic device 401 and/or the distance to the object. For example, the electronic device 401 may be positioned within a mart. When the electronic device 401 is positioned at an entrance of the mart, the visualization module 435 may provide a visual effect for each region of the mart. When the electronic device 401 is entering a specific region among a plurality of regions, the visualization module 435 may provide a visual effect in units of objects in the specific region. When the electronic device 401 is adjacent to a specific object among objects, the visualization module 435 may provide a visual effect based on a surface of the object. For example, the visualization module 435 may identify the position of the electronic device 401 using images acquired using the camera 480 and/or an image acquired using the position sensor 450.

For example, the electronic device 401 may provide information corresponding to the user by providing a visual effect that matches a user's profile based on the position of the user. The electronic device 401 may provide information that matches a user's intention by providing visual effects in different ways depending on a distance between the user and the object. The electronic device 401 may reduce visual fatigue of the user by providing a visual effect depending on the position of the user and the distance between the user and the object. The effects described above are merely provided as examples, and embodiments of the disclosure may have different effects in addition to the effects described above.

Hereinafter, various embodiments in which the electronic device 401 provides visual effects may be described with reference to FIGS. 5 to 15.

FIG. 5 illustrates three-dimensional segmentation according to an embodiment of the disclosure.

Referring to FIGS. 4 and 5, an electronic device 401 may perform three-dimensional (3D) segmentation. For example, the electronic device 401 may perform 3D segmentation using the 3D segmentation module 431. In the example of FIG. 5, a segmented environment 500 may include a plurality of identified objects. The electronic device 401 may identify a plurality of objects and assign identifiers to the objects. In an example, the electronic device 401 may identify an object in space, a position of the object, and/or a type of object through the 3D segmentation. The segmented environment 500 in FIG. 5 is merely an example, and the embodiments of the disclosure are not limited thereto.

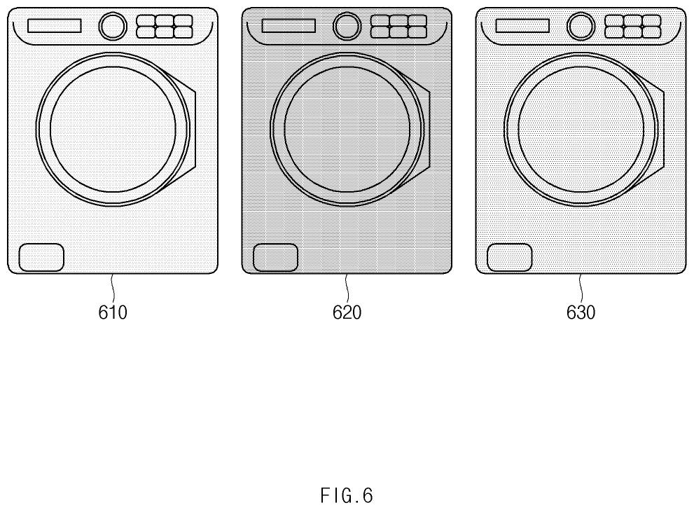

FIG. 6 illustrates object-based gaze point analysis according to an embodiment of the disclosure.

Referring to FIGS. 4 and 6, according to an embodiment, an electronic device 401 may perform object-based gaze point analysis. For example, the electronic device 401 may perform the gaze point analysis using the gaze point analysis module 433. In the example of FIG. 6, a first object 610, a second object 620, and a third object 630 are illustrated. In the example of FIG. 6, similar to a heat map, for the longer the gaze time, the darker the shade of the object may be illustrated. In the example of FIG. 6, the gaze time for the second object 620 may be relatively high compared to that for the first object 610 and the third object 630. In the object-based gaze point analysis, a gaze degree may be expressed in units of objects. The electronic device 401 may count a user's gaze at any point on the object as gaze toward that object.

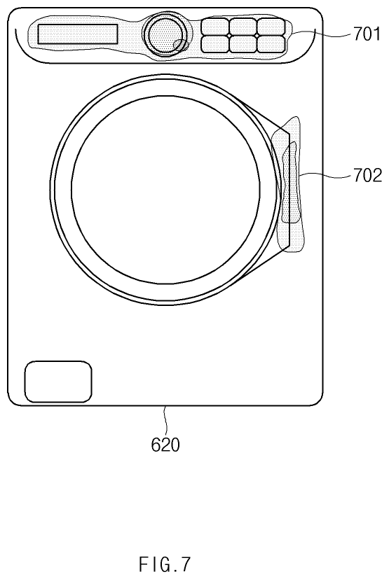

FIG. 7 illustrates surface-based gaze point analysis according to an embodiment of the disclosure.

Referring to FIGS. 4 and 7, according to an embodiment, an electronic device 401 may perform object surface-based gaze point analysis. For example, the electronic device 401 may perform gaze point analysis using the gaze point analysis module 433. In the example of FIG. 7, a gaze point for the second object 620 is illustrated in the form of a heat map. In the example of FIG. 7, a gaze time for some regions (e.g., a first region 701 and a second region 702) of the second object 620 may be relatively high compared to other regions. In the surface-based gaze point analysis, the gaze degree may be expressed in units of a portion within the object (e.g., the first region 701 and/or the second region 702). The electronic device 401 may identify a point at which the user gazes within the object and identify a region of high interest to the user within the corresponding object. In the example of FIG. 7, the first region 701 and the second region 702 are illustrated to have darker shades as the gaze time increases.

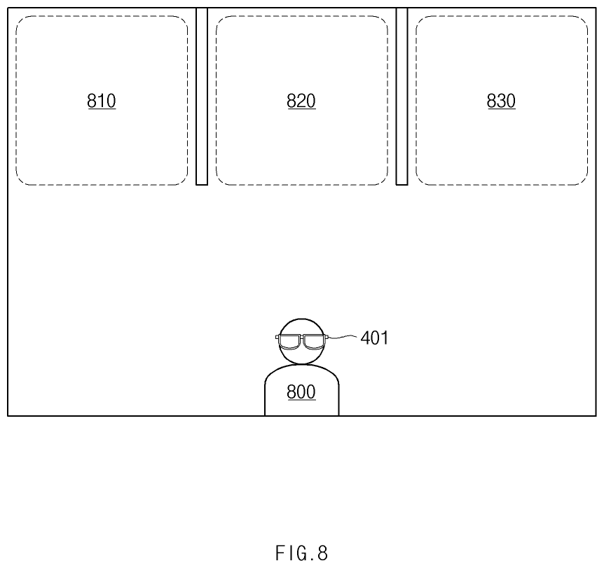

FIG. 8 illustrates a spatial configuration according to an embodiment of the disclosure.

Referring to FIGS. 4 and 8, a user 800 may be wearing an electronic device 401. For example, the user 800 may be in a situation of arriving at the entrance of a mart. In an example, a first region 810 may correspond to a home appliance corner, a second region 820 may correspond to a sports corner, and a third region 830 may correspond to a food corner. In the example of FIG. 8, embodiments are described based on an AR environment, but embodiments of the disclosure are not limited thereto. For example, even in a VR environment, the electronic device 401 may provide a visual effect. For example, the first region 810, the second region 820, and the third region 830 may be regions within a VR space.

According to an embodiment, the electronic device 401 may acquire 3D segmentation information corresponding to the position of the electronic device 401 using the position sensor 450. For example, the electronic device 401 may acquire 3D segmentation information corresponding to the position (e.g., the mart) of the electronic device 401 from the memory 430. For example, the electronic device 401 may request 3D segmentation information along with position information about the electronic device 401 from a server (e.g., the server device 1200 in FIG. 12). For example, the electronic device 401 may request 3D segmentation information corresponding to the position of the electronic device 401 from the server. The electronic device 401 may receive the 3D segmentation information from the server in response to the request. For example, the 3D segmentation information may include at least one of a region division information corresponding to the position of the electronic device 401 (e.g., the mart) or information about objects within the region.

According to an embodiment, the electronic device 401 may acquire gaze point information based on a profile of the user 800 of the electronic device 401 (e.g., at least one of the user's gender, age, interests, or residence region). For example, the electronic device 401 may acquire the gaze point information stored in the memory 430. For example, the electronic device 401 may transmit gaze point information including information about the user 800 (e.g., the profile and/or identification information about the user 800) to a server (e.g., the server device 1200 in FIG. 12). The electronic device 401 may, in response to the request, receive gaze point information corresponding to the profile of the user 800 from the server. In an example, the gaze point information may include a region-specific interest, an object-specific interest, and/or a component-specific interest within the object corresponding to the profile of the user 800. The region-specific interest may include information indicating statistical interests in regions of users corresponding to the profile of the user 800. The object-specific interest may include information indicating statistical interests of users corresponding to the profile of the user 800 for objects. The component-specific interest may include information indicating statistical interests of users corresponding to the profile of the user 800 in the components.

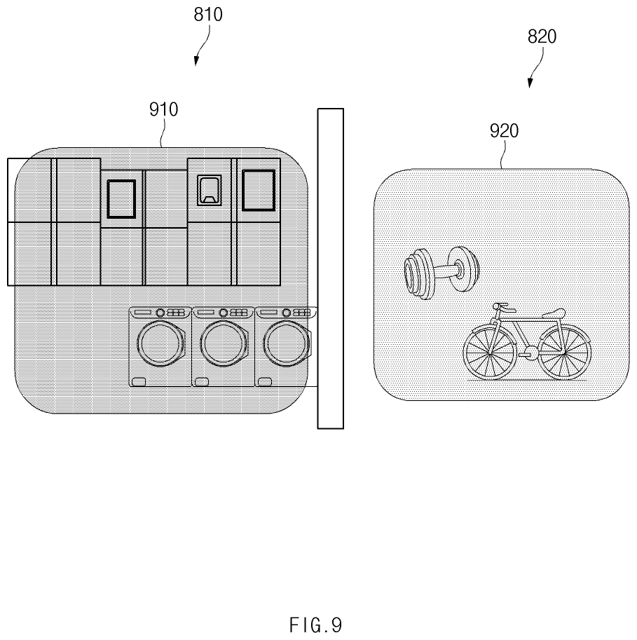

FIG. 9 illustrates a first visual effect according to an embodiment of the disclosure.

Referring to FIGS. 4, 8, and 9, according to an embodiment, an electronic device 401 may provide a first visual effect based on the position of the electronic device 401. For example, the first visual effect may refer to a visual effect provided in units of regions within a space. The example of FIG. 9 shows an example of an AR environment that the user 800 sees through the display 460. The user 800 may be viewing the first region 810 and the second region 820. The electronic device 401 may identify the position of the electronic device 401 using, for example, the position sensor 450. For example, the electronic device 401 may identify the position of the electronic device 401 based on simultaneous localization and mapping (SLAM). In the example of FIG. 9, embodiments are described based on the AR environment, but embodiments of the disclosure are not limited thereto. For example, even in the VR environment, the electronic device 401 may provide a visual effect. For example, the first region 810 and the second region 820 may be regions within the VR space.

For example, the electronic device 401 may be positioned at the entrance of the mart. The electronic device 401 may not belong to any of set regions (e.g., the first region 810, the second region 820, and the third region 830). In this case, the electronic device 401 may provide the first visual effect based on a region division. The electronic device 401 may provide a first-first visual effect 910 for the first region 810 and a first-second visual effect 920 for the second region 820 based on the gaze point information. For example, the electronic device 401 may display the first-first visual effect 910 at a position corresponding to the first region 810 of the display 460.

In the example of FIG. 9, the gaze point information may indicate that the corresponding interest of the user 800 for the first region 810 is relatively high compared to that for the second region 820. In this case, the first-first visual effect 910 for the first region 810 may be highlighted compared to the first-second visual effect 920 for the second region 820. The first visual effect illustrated in FIG. 9 is merely an example, and the embodiments of the disclosure are not limited thereto. Any visual effect to highlight regions of relatively high interest may be used in embodiments of the disclosure.

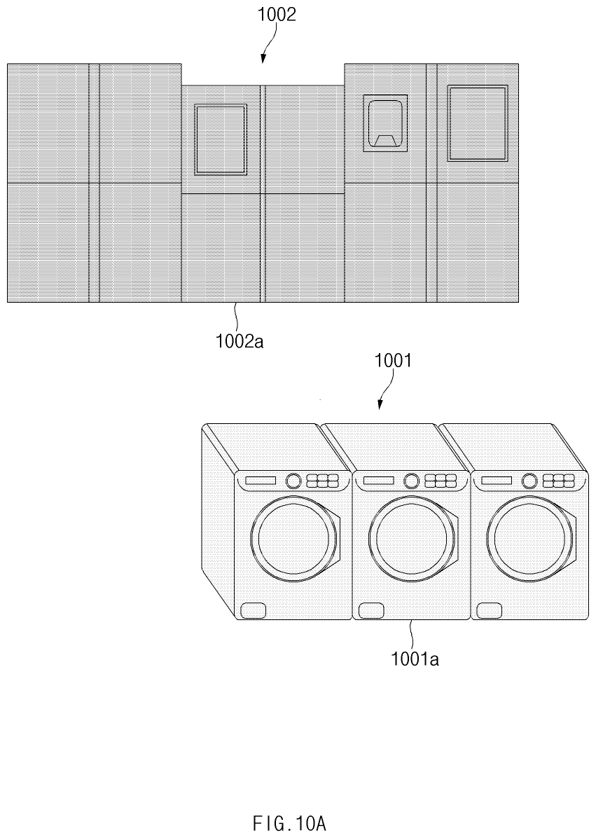

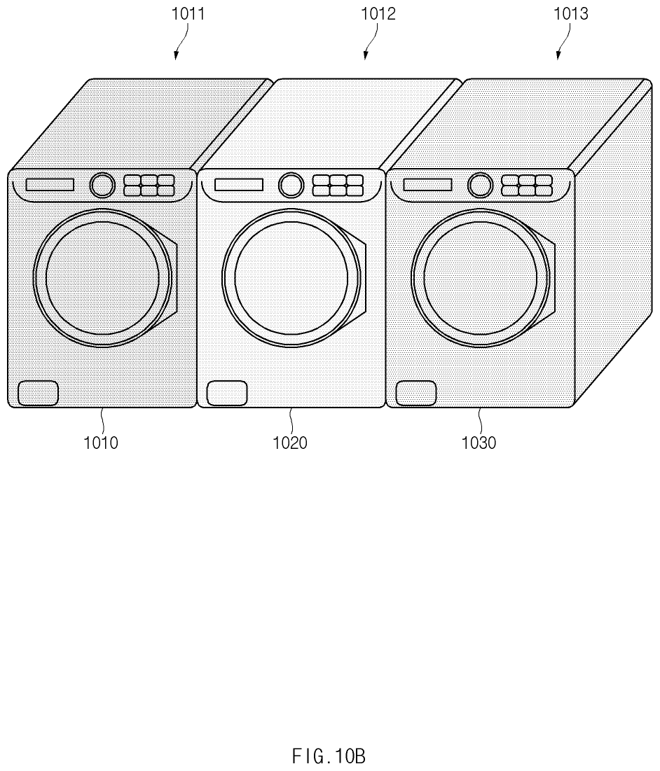

FIG. 10A illustrates a second visual effect according to an embodiment of the disclosure.

Referring to FIGS. 4, 8, and 10A, according to an embodiment, an electronic device 401 may provide the second visual effect based on the position of the electronic device 401. For example, the second visual effect may refer to a visual effect provided in units of objects. The example of FIG. 10A shows an example of an AR environment that the user 800 sees through the display 460. It may be assumed that the user 800 has entered the first region 810. For example, the electronic device 401 may identify the position of the electronic device 401 using the position sensor 450. For example, the electronic device 401 may identify the position of the electronic device 401 based on simultaneous localization and mapping (SLAM). In the example of FIG. 10A, embodiments are described based on the AR environment, but embodiments of the disclosure are not limited thereto. For example, even in the VR environment, the electronic device 401 may provide a visual effect. For example, a first object group 1001 and a second object group 1002 may be virtual objects within the VR space.

For example, the electronic device 401 may be positioned within the first region 810. The electronic device 401 may belong to the first region 810 among the set regions (e.g., the first region 810, the second region 820, and the third region 830). The user 800 may view the first object group 1001 and the second object group 1002 of the first region 810 through the display 460. In this case, the electronic device 401 may provide the second visual effect in units of object groups. The electronic device 401 may provide a second-first visual effect 1001a for the first object group 1001 and a second-second visual effect 1002a for the second object group 1002 based on the gaze point information. For example, the electronic device 401 may provide the second-first visual effect 1001a to a region of the display 460 corresponding to the first object group 1001. The electronic device 401 may provide the second-second visual effect 1002a to a region of the display 460 corresponding to the second object group 1002.

In the example of FIG. 10A, the gaze point information may indicate that the corresponding interest of the user 800 for the second object group 1002 is relatively high compared to that for the first object group 1001. In this case, the second-second visual effect 1002a for the second object group 1002 may be more highlighted than the second-first visual effect 1001a for the first object group 1001. The second visual effect illustrated in FIG. 10A is merely an example, and the embodiments of the disclosure are not limited thereto. Any visual effect to highlight object groups of relatively high interest may be used in embodiments of the disclosure.

According to an embodiment, an object group may include objects having the same properties. For example, electronic devices of the same type may belong to the same object group. For example, media containing content of the same genre (e.g., books, videos, digital versatile discs (DVDs), Blu-ray discs, or the like) may belong to the same object group. For example, objects belonging to the same academic classification (e.g., biology, food science, sociology, or the like) may belong to the same object group. For example, vegetables may belong to one object group.

FIG. 10B illustrates a third visual effect according to an embodiment of the disclosure.

Referring to FIGS. 4, 8, and 10B, according to an embodiment, an electronic device 401 may provide a third visual effect based on the position of the electronic device 401. For example, the third visual effect may refer to a visual effect provided in units of objects. The example of FIG. 10B shows an example of an AR environment that the user 800 sees through the display 460. It may be assumed that the user 800 has entered the first region 810. In the example of FIG. 10B, it may be assumed that the user 800 has moved closer to the first object group 1001 than in a situation in FIG. 10A. For example, the electronic device 401 may identify the position of the electronic device 401 using the position sensor 450. For example, the electronic device 401 may identify the position of the electronic device 401 based on simultaneous localization and mapping (SLAM). The electronic device 401 may change the target and unit of visualization according to the movement of the user 800. For example, the electronic device 401 may provide a visual effect in units of spaces at a long distance, in units of object groups at an intermediate distance, in units of objects at a short distance, and in units of components within the object at an extremely short distance. For example, the distance may be identified based on the size of the visualization target within a captured image and/or the position of the electronic device 401.

In the example of FIG. 10B, embodiments are described based on the AR environment, but embodiments of the disclosure are not limited thereto. For example, even in the VR environment, the electronic device 401 may provide a visual effect. For example, a first object 1010, a second object 1020, and a third object 1030 may be virtual objects within the VR space.

For example, the electronic device 401 may be positioned within the first region 810. The electronic device 401 may belong to the first region 810 among the set regions (e.g., the first region 810, the second region 820, and the third region 830). The user 800 may view the first object 1010, the second object 1020, and the third object 1030 of the first region 810 through the display 460. In this case, the electronic device 401 may provide the second visual effect based on the object. The electronic device 401 may provide a third-first visual effect 1011 for the first object 1010, a third-second visual effect 1012 for the second object 1020, and a third-third visual effect 1013 for the third object 1030 based on the gaze point information. For example, the electronic device 401 may provide the third-first visual effect 1011 to a region of the display 460 corresponding to the first object 1010. The electronic device 401 may provide the third-second visual effect 1012 to a region of the display 460 corresponding to the second object 1020. The electronic device 401 may provide the third-third visual effect 1013 to a region of the display 460 corresponding to the third object 1030.

In the example of FIG. 10B, the gaze point information may indicate that the corresponding interest of the user 800 for the first object 1010 is relatively high compared to than those for the second object 1020 and the third object 1030. In this case, the third-first visual effect 1011 for the first object 1010 may be highlighted compared to the third-second visual effect 1012 for the second object 1020 and the third-third visual effect 1013 for the third object 1030. The third visual effect illustrated in FIG. 10B is merely an example, and the embodiments of the disclosure are not limited thereto. Any visual effect to highlight the object of relatively high interest may be used in embodiments of the disclosure.

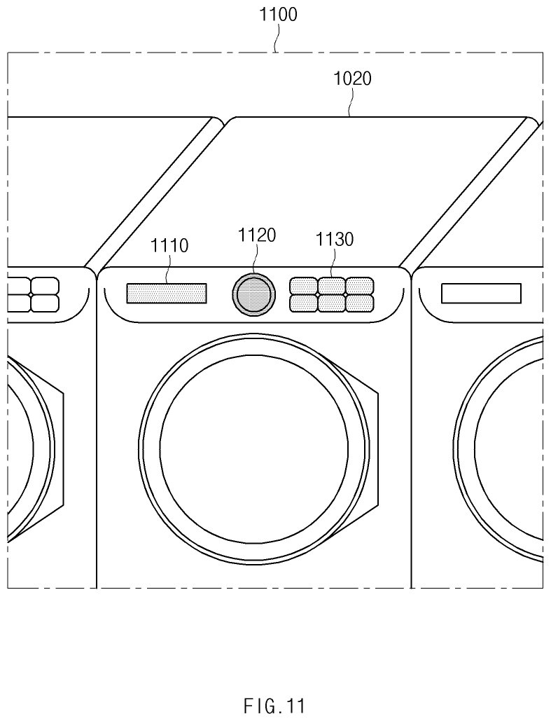

FIG. 11 illustrates a fourth visual effect according to an embodiment of the disclosure.

Referring to FIGS. 4, 8, and 11, according to an embodiment, an electronic device 401 may provide a fourth visual effect based on a distance between the electronic device 401 and an object (e.g., a size of an object in an acquired image). For example, the fourth visual effect may refer to a visual effect provided in units of components within the object. The example of FIG. 11 shows an example of an AR environment 1100 that the user 800 sees through the display 460. In the example of FIG. 11, embodiments are described based on an AR environment, but embodiments of the disclosure are not limited thereto. For example, even in the VR environment, the electronic device 401 may provide a visual effect. For example, a first component 1110, a second component 1120, and a third component 1130 may be virtual objects within the VR space.

It may be assumed that the user 800 has moved to a position adjacent to the second object 1020. For example, the electronic device 401 may acquire an image using the camera 480 and determine that the electronic device 401 is adjacent to the second object 1020 based on the size of the second object 1020 in the acquired image. The electronic device 401 may provide the fourth visual effect when the electronic device 401 determines that it is adjacent to a specific object. The electronic device 401 may provide the third visual effect when the size of a specific object acquired by the camera is equal to or greater than a specified size.

The user 800 may view the second object 1020 through the display 460. In this case, the electronic device 401 may provide the third visual effect based on the object. The gaze point information may include, for example, interest information for the first component 1110, the second component 1120, and the third component 1130 within the second object 1020. The electronic device 401 may provide a fourth visual effect for the first component 1110, the second component 1120, and the third component 1130 based on the gaze point information.

In the example of FIG. 11, the gaze point information may indicate that the corresponding interest of the user 800 for the second component 1120 is relatively high compared to those for the first component 1110 and the third component 1130. In this case, the fourth visual effect for the second component 1120 may be highlighted compared to the fourth visual effects for the first component 1110 and the third component 1130. The fourth visual effect illustrated in FIG. 11 is merely an example, and the embodiments of the disclosure are not limited thereto. Any visual effect to highlight the component of relatively high interest may be used in embodiments of the disclosure.

Referring to FIGS. 8 to 11, visual effects have been described with a focus on interest, but the embodiments of the disclosure are not limited thereto. For example, interests may include information set by users or content providers as well as statistical information.

FIG. 12 is a signal flow diagram of a method for analyzing a gaze point according to an embodiment of the disclosure.

Referring to FIGS. 4 and 12, according to an embodiment, an electronic device 401 may transmit gaze point information to the server device 1200. In operation 1205, the electronic device 401 may acquire the gaze point information. For example, the electronic device 401 may acquire the gaze point information using the gaze point analysis module 433. The electronic device 401 may acquire gaze point information for a space where 3D segmentation is performed. The electronic device 401 may acquire information about a region, object, and/or component within an object at which the user is gazing as the gaze point information. For example, gaze point information for a region may include at least one piece of information about a period of time when the user gazes at regions within the space, information about the regions gazed at for a certain period of time or longer, or information about a period of time when the user has stayed at the regions. For example, gaze point information for objects may include at least one piece of information about a period of time for which or frequencies with which the user has gazed at the objects. The gaze point information for objects may be generated based on object-based gaze point analysis. For example, gaze point information for components may include at least one piece of information about a period of time for which or frequencies with which the user has gazed at components within the object. The gaze point information for components may be generated based on surface-based gaze point analysis.

In operation 1210, the electronic device 401 may transmit gaze point information, position information, and user information to the server device 1200. For example, the electronic device 401 may transmit the gaze point information, position information, and user information to the server device 1200 using the communication circuitry 490. For example, the electronic device 401 may identify the position of the electronic device 401 using the position sensor 450. For example, the user information may include, for example, at least one of the gender, age, interests, or residence region of the user.

In operation 1211, an external electronic device 1201 (e.g., an electronic device used by a user other than the user of the electronic device 401) may acquire gaze point information. For example, the external electronic device 1201 may acquire gaze point information in a similar manner to the electronic device 401. For example, the external electronic device 1201 may acquire gaze point information for the same space as the electronic device 401.

In operation 1213, an external electronic device 1201 may transmit the gaze point information, position information, and user information to the server device 1200.

In operation 1215, the server device 1200 may analyze and store the gaze point of the corresponding position based on information received from a plurality of electronic devices including the electronic device 401 and the external electronic device 1201. For example, the server device 1200 may map the received gaze point information and a user profile and store them in a database. The server device 1200 may generate statistical gaze point information corresponding to the user profile by receiving the gaze point information, position information, and user information from the plurality of electronic devices. For example, the server device 1200 may include information about regions, objects, and components within objects that are of interest to users of a specific age in the gaze point information.

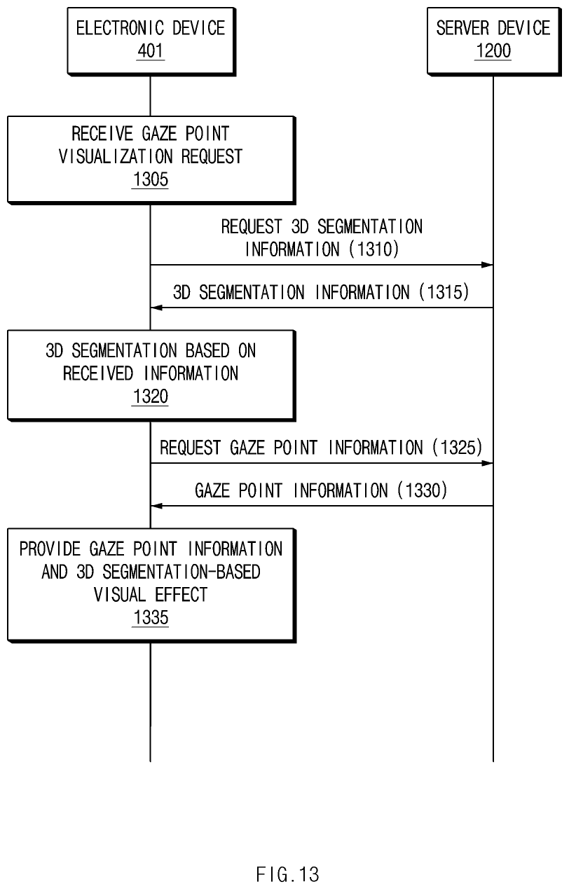

FIG. 13 is a signal flow diagram of a method for providing a visual effect according to an embodiment of the disclosure.

Referring to FIGS. 4 and 13, in operation 1305, an electronic device 401 may receive a gaze point visualization request. For example, the electronic device 401 may receive the gaze point visualization request based on a user input.

In operation 1310, the electronic device 401 may request 3D segmentation information. For example, the electronic device 401 may transmit the 3D segmentation request including position information about the electronic device 401 to the server device 1200.

In operation 1315, the server device 1200 may transmit the 3D segmentation information to the electronic device 401. For example, the server device 1200 may store the 3D segmentation information for a plurality of spaces. The server device 1200 may identify 3D segmentation information corresponding to the position information using the position information about the electronic device 401. The server device 1200 may transmit the identified 3D segmentation information to the electronic device 401 in response to the 3D segmentation information request.

In operation 1320, the electronic device 401 may perform 3D segmentation based on the received information. For example, the electronic device 401 may perform segmentation of a 3D space using the 3D segmentation module 431. Through the three-dimensional segmentation, the electronic device 401 may perform segmentation of regions, objects, and/or components for the 3D space. By matching the segmentation by the electronic device 401 with the received 3D segmentation information, the electronic device 401 may acquire information about each region, object, and/or component. For example, the electronic device 401 may acquire the type of object identified by the electronic device 401 from the received 3D segmentation information.

In an example, the 3D segmentation information stored in the server device 1200 may not match the actual 3D space. For example, objects within the 3D space or the positions of objects may change. In this case, the electronic device 401 may transmit the information about the 3D segmentation performed by the electronic device 401 to the server device 1200, thereby allowing the server device 1200 to update the 3D segmentation information.

In operation 1325, the electronic device 401 may transmit a gaze point information request to the server device 1200. For example, the gaze point information request may include information about a user profile of the electronic device 401 (e.g., at least one of the user's gender, age, interests, or residence region).

In operation 1330, the server device 1200 may transmit gaze point information to the electronic device 401. For example, the server device 1200 may transmit gaze point information corresponding to the user profile to the electronic device 401. The gaze point information may be information generated by the server device 1200 according to the method described above with reference to FIG. 12, for example.

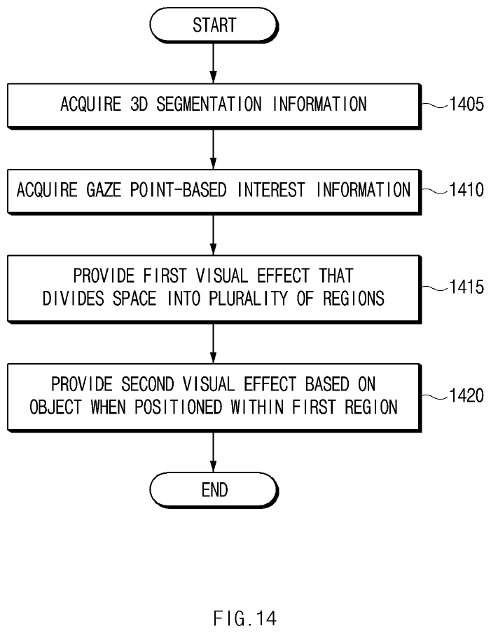

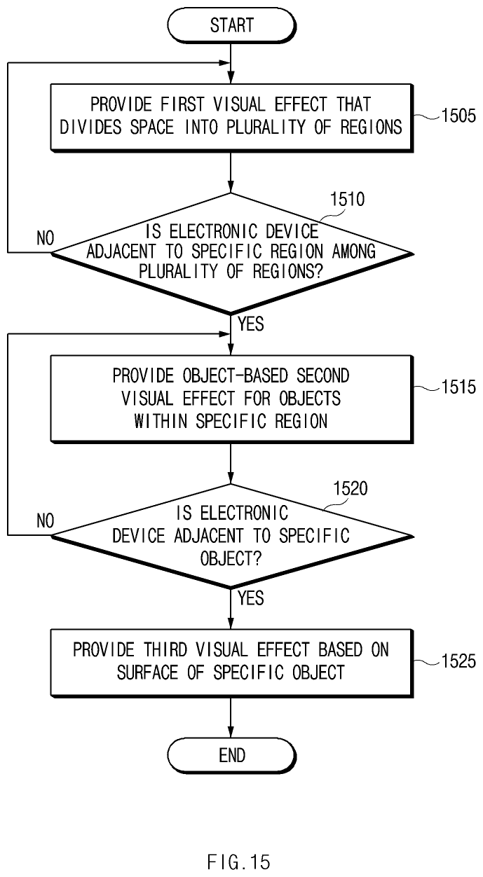

In operation 1335, the electronic device 401 may provide the gaze point information and a 3D segmentation-based visual effect. The providing of the visual effect may be referred to as by various examples described above with reference to FIGS. 8 to 11 and the method for providing a visual effect described below with reference to FIGS. 14 and 15.

FIG. 14 is a flowchart of a method for providing a position-based visual effect according to an embodiment of the disclosure.

Referring to FIGS. 4 and 14, according to an embodiment, an electronic device 401 may provide a visual effect based on the position of the electronic device 401. In operation 1405, the electronic device 401 may acquire 3D segmentation information. For example, the electronic device 401 may identify the position of the electronic device 401 using the position sensor 450 and acquire 3D segmentation information about a space corresponding to the identified position. In an example, the electronic device 401 may acquire 3D segmentation information corresponding to the identified position in 3D segmentation information stored in the memory 430. In an example, the electronic device 401 may acquire 3D segmentation information from an external server device (e.g., operation 1315 in FIG. 13).

In operation 1410, the electronic device 401 may acquire gaze point-based interest information. For example, the electronic device 401 may acquire gaze point-based interest information corresponding to a user profile (e.g., at least one of the user's gender, age, interests, or residence region). In an example, gaze point-based interest information may include region-specific interests, object-specific interests, and/or component-specific interests within an object corresponding to the profile of the user 800. The electronic device 401 may acquire gaze point-based interest information from the memory 430. The electronic device 401 may acquire gaze point-based interest information from an external server device (e.g., operation 1330 in FIG. 13).

In operation 1415, the electronic device 401 may provide the first visual effect dividing space into a plurality of regions. For example, the first visual effect may be a visual effect provided in units of spatial regions (e.g., the first visual effect described above with reference to FIG. 9). For example, the electronic device 401 may provide a first visual effect when the position of the electronic device 401 is at a specific position within a specific space (e.g., a position that does not belong to any of a plurality of regions) or when the electronic device 401 enters a specific space. The first visual effect may indicate region-specific interests corresponding to the user profile.

In operation 1420, the electronic device 401 may provide an object-based second visual effect when positioned within a first region. For example, the electronic device 401 may use the position sensor 450 to identify that the electronic device 401 is positioned within the first region among a plurality of regions. For example, the second visual effect may be a visual effect provided in units of objects within the region (e.g., the third visual effect described above with reference to FIG. 10B). The second visual effect may indicate object-specific interest corresponding to the user profile. As described above with reference to FIG. 10B, the electronic device 401 may provide a visual effect for each object group. For example, the electronic device 401 may provide a visual effect for each object group when the electronic device 401 is positioned within the first region and outside a first distance from the object group. For example, the electronic device 401 may provide a visual effect in units of objects when the electronic device 401 is positioned within the first region and within the first distance from the object group.

FIG. 15 is a flowchart of a method for providing a position-based visual effect according to an embodiment of the disclosure.

Referring to FIGS. 4 and 15, in operation 1505, an electronic device 401 may provide a first visual effect that divides space into a plurality of regions. For example, the electronic device 401 may provide the first visual effect according to operation 1405 in FIG. 14.

In operation 1510, the electronic device 401 may determine whether the electronic device 401 is adjacent to a specific region among the plurality of regions. In an example, the electronic device 401 may use a position sensor 450 to determine whether the electronic device 401 is adjacent to a specific region. In an example, the electronic device 401 may determine whether the electronic device 401 is adjacent to a specific region based on SLAM. The electronic device 401 may determine that the electronic device 401 is adjacent to the specific region when the position of the electronic device is within a specified distance from the specific region or within the specific region. When not adjacent to the specific region (e.g., NO in operation 1510), the electronic device 401 may continue to provide the first visual effect.

After operation 1510, the electronic device 401 may provide a visual effect in units of object groups as described above with reference to FIG. 10A. In an example, the electronic device 401 may provide a visual effect in units of object groups when the electronic device is adjacent to the specific region and positioned outside the specified distance from the object group. In an example, the electronic device 401 may provide a visual effect in units of objects according to operation 1510 when the electronic device is positioned within the specified distance from the object group.

When adjacent to the specific region (e.g., YES in operation 1510), in operation 1515, the electronic device 401 may provide an object-based second visual effect (e.g., the third visual effect in FIG. 10B) for objects within the specific region. For example, the electronic device 401 may provide the second visual effect according to operation 1420 in FIG. 14.

In operation 1520, the electronic device 401 may determine whether the electronic device is adjacent to a specific object. For example, the electronic device 401 may acquire an image of the front of the electronic device 401 using the camera 480. The electronic device 401 may determine that the electronic device 401 is adjacent to the specific object when the size of the specific object within the acquired image is equal to or greater than a specified size. When not adjacent to a specific object (e.g., NO in operation 1520), the electronic device 401 may continue to provide the second visual effect.

When adjacent to the specific object (e.g., YES in operation 1520), in operation 1525, the electronic device 401 may provide a third visual effect based on the surface of the specific object. For example, the third visual effect may refer to a visual effect provided in units of components within the object. The electronic device 401 may provide the third visual effect according to, for example, the examples of the fourth visual effect described above with reference to FIG. 11.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A head mounted display (HMD) device comprising:
a display;
a gaze sensor configured to detect a gaze direction of a user of the HMD device;
a camera;
a position sensor configured to detect a position of the HMD device;
communication circuitry;
memory storing one or more computer programs; and
one or more processors communicatively coupled to the display, the gaze sensor, the camera, the position sensor, the communication circuitry, and the memory,
wherein the one or more computer programs include computer-executable instructions that, when executed by the one or more processors individually or collectively, cause the HMD device to:
based on the position of the HMD device, acquire three-dimensional (3D) segmentation information for a space corresponding to the position of the HMD device,
acquire gaze point-based interest information corresponding to a profile of the user, the gaze point-based interest information including interest information generated based on gaze points of a plurality of users,
display, on the display, a first visual effect for a plurality of regions in the space based on the 3D segmentation information and the interest information, and
display, on the display, a second visual effect for a plurality of objects in a first region among the plurality of regions based on the 3D segmentation information and the interest information when the position of the HMD device corresponds to the first region.

2. The HMD device of claim 1,
wherein the profile includes at least one of gender, age, region of interest, or a residence region of the user, and
wherein the interest information is generated by an external server device from gaze point information corresponding to the plurality of users.

3. The HMD device of claim 2,
wherein the interest information includes user statistics-based interest information for each of the plurality of regions, and
wherein the one or more computer programs further include computer-executable instructions that, when executed by the one or more processors individually or collectively, cause the HMD device to:
provide different visual effects to the first region and a second region among the plurality of regions using the interest information.

4. The HMD device of claim 2,
wherein the interest information includes user statistics-based interest information for each of the plurality of objects, and
wherein the one or more computer programs further include computer-executable instructions that, when executed by the one or more processors individually or collectively, cause the HMD device to:
provide different visual effects to a first object among the plurality of objects and a second object among the plurality of objects using the interest information.

5. The HMD device of claim 1, wherein the one or more computer programs further include computer-executable instructions that, when executed by the one or more processors individually or collectively, cause the HMD device to:
provide a third visual effect based on a first object among the plurality of objects acquired using the camera when a size of the first object is less than a first size, and
provide a fourth visual effect based on a component of the first object acquired using the camera when the size of the first object is equal to or greater than the first size.

6. The HMD device of claim 1, wherein the one or more computer programs further include computer-executable instructions that, when executed by the one or more processors individually or collectively, cause the HMD device to:
provide a third visual effect in a unit of a first object among the plurality of objects acquired using the camera when a size of the first object is less than a first size, and
provide a fourth visual effect in a unit of a component within the first object acquired using the camera when the size of the first object is equal to or greater than the first size.

7. The HMD device of claim 1, wherein the one or more computer programs further include computer-executable instructions that, when executed by the one or more processors individually or collectively, cause the HMD device to:
transmit, through the communication circuitry to an external server device, a 3D segmentation information request including position information about the HMD device, and
in response to transmitting the 3D segmentation information request, receive, through the communication circuitry from the external server device, the 3D segmentation information.

8. The HMD device of claim 7, wherein the one or more computer programs further include computer-executable instructions that, when executed by the one or more processors individually or collectively, cause the HMD device to:
identify the position of the HMD device within the space by mapping information about the space corresponding to the position of the HMD device included in the 3D segmentation information with an image acquired using the camera.

9. The HMD device of claim 7, wherein the one or more computer programs further include computer-executable instructions that, when executed by the one or more processors individually or collectively, cause the HMD device to:
transmit, through the communication circuitry to the external server device, an image of the space acquired using the camera for updating the 3D segmentation information when the image of the space acquired using the camera does not correspond to the 3D segmentation information.

10. The HMD device of claim 7, wherein the one or more computer programs further include computer-executable instructions that, when executed by the one or more processors individually or collectively, cause the HMD device to:
identify a gaze point of the user within the space using the camera and the gaze sensor, and
transmit, through the communication circuitry to the external server device, information about the gaze point for user statistics of the interest information.

11. The HMD device of claim 1, wherein the one or more computer programs further include computer-executable instructions that, when executed by the one or more processors individually or collectively, cause the HMD device to:
acquire, using the camera, an image of the space corresponding to a front of the user,
identify the plurality of regions using the image and the 3D segmentation information, and
display the first visual effect by displaying a visual effect at a position corresponding to the plurality of regions seen by the user through the display.

12. A method performed by a head mounted display (HMD) device for providing a visual effect, the method comprising:
based on a position of the HMD device, acquiring, by the HMD device, three-dimensional (3D) segmentation information for a space corresponding to the position of the HMD device;
acquiring, by the HMD device, gaze point-based interest information corresponding to a profile of a user of the HMD device, the gaze point-based interest information including interest information generated based on gaze points of a plurality of users;
displaying, by the HMD device on a display of the HMD device, a first visual effect for a plurality of regions in the space based on the 3D segmentation information and the interest information; and
displaying, by the HMD device on the display, a second visual effect for a plurality of objects in a first region among the plurality of regions based on the 3D segmentation information and the interest information in response to the position of the HMD device corresponding to the first region.

13. The method of claim 12,
wherein the profile includes at least one of gender, age, region of interest, or a residence region of the user, and
wherein the interest information is generated in an external server device from gaze point information corresponding to the plurality of users.

14. The method of claim 13,
wherein the interest information includes user statistics-based interest information for each of the plurality of regions, and
wherein the displaying of the first visual effect on the display of the HMD device includes providing different visual effects to the first region and a second region among the plurality of regions using the interest information.

15. The method of claim 13,
wherein the interest information includes user statistics-based interest information for each of the plurality of objects, and
wherein the displaying of the second visual effect on the display includes providing different visual effects to a first object among the plurality of objects and a second object among the plurality of objects using the interest information.

16. The method of claim 12, further comprising:
providing, by the HMD device, a third visual effect based on a first object among the plurality of objects acquired using a camera of the HMD device in response to a size of the first object being less than a first size, and
providing, by the HMD device, a fourth visual effect based on a component of the first object acquired using the camera in response to the size of the first object being equal to or greater than the first size.

17. The method of claim 12, further comprising:
providing, by the HMD device, a third visual effect in a unit of a first object among the plurality of objects acquired using a camera in response to a size of the first object being less than a first size, and
providing, by the HMD device, a fourth visual effect in a unit of a component within the first object acquired using the camera in response to the size of the first object being equal to or greater than the first size.

18. The method of claim 12, further comprising:
transmitting, by the HMD device to an external server device, a 3D segmentation information request including position information about the HMD device; and
in response to transmitting the 3D segmentation information request, receiving, by the HMD device from the external server device, the 3D segmentation information.

19. One or more non-transitory computer-readable storage media storing one or more computer programs including computer-executable instructions that, when executed by one or more processors of a head-mounted display (HMD) device individually or collectively, cause the HMD device to perform operations, the operations comprising:
based on a position of the HMD device, acquiring, by the HMD device, three-dimensional (3D) segmentation information for a space corresponding to the position of the HMD device;
acquiring, by the HMD device, gaze point-based interest information corresponding to a profile of a user of the HMD device, the gaze point-based interest information including interest information generated based on gaze points of a plurality of users;
displaying, by the HMD device on a display of the HMD device, a first visual effect for a plurality of regions in the space based on the 3D segmentation information and the interest information; and
displaying, by the HMD device on the display, a second visual effect for a plurality of objects in a first region among the plurality of regions based on the 3D segmentation information and the interest information in response to the position of the HMD device corresponding to the first region.

20. The one or more non-transitory computer-readable storage media of claim 19, the operations further comprising:
transmitting, by the HMD device to an external server device, a 3D segmentation information request including position information about the HMD device; and
in response to transmitting the 3D segmentation information request, receiving, by the HMD device from the external server device, the 3D segmentation information.
